(19) United States
(12) Patent Application Publication
(10) Pub. No.: US 2011/0192806 A1
(43) Pub. Date: Aug. 11, 2011

(54) Chemical Delivery Media and Methods of Preparation and Use

(76) Inventor: Longchun Cheng, Pennington, NJ (US)

(21) Appl. No.: 12/702,278

(22) Filed: Feb. 8, 2010

(51) Int. Cl. C02F 1/68; B32B 3/26; B32B 9/00; B32B 5/02; B05D 3/02; C09K 3/00; B01D 39/14; C02F 5/00; C02F 1/00; B01F 1/00; C23F 11/00; B01D 39/00

(52) U.S. Cl. 210/749; 427/372.2; 106/311; 106/400; 422/261; 210/263; 210/198.1; 210/506; 422/7

(57) ABSTRACT

The present invention discloses integrated chemical delivery media that comprise a substrate and incorporated chemical additives. The invention also teaches methods of preparing such chemical delivery media as well as the use of such media for water treatment applications.

### FIELD OF INVENTION

This disclosure relates generally to the field of delivery of water treatment chemicals to an aqueous environment to prevent corrosion, scale formation, and microbiological growth. In particular, the disclosure relates to delivering chemical additives with low water solubility and/or low aqueous chemical stability. Aspects of the disclosure also provide methods of producing such delivery media and methods of using such media in delivering chemicals for water treatment purposes.

### BACKGROUND OF THE INVENTION

A wide variety of water systems are used for industrial and commercial purposes. Typical water systems include open and closed cooling systems, boilers, wastewater treatment facilities, air conditioning and refrigeration systems, thermal desalination systems, etc. Chemical materials are widely used in these systems for a great variety of purposes such as metal corrosion inhibition, deposit and scale control, and microbiological control. For field applications, water treatment chemicals are normally prepared in a liquid form to be delivered to the water system through a mechanical pumping system or by manual addition. The chemical additives could therefore be effectively mixed with the system water to reach desired concentration levels. Since the chemical additives are to be mixed with system water to achieve maximum treatment efficiency, concentrated treatment chemical products are often produced for field applications.

To produce concentrated products for water systems, chemical additives are often prepared in aqueous media. For chemical additives that are not stable in water, appropriate organic solvents are often used. In some cases, organic solvents are also used where chemical additives are not readily water soluble.

An example of such additives is tolylbenzotriazole, a commonly used copper corrosion inhibitor. Its solubility in water is less than 0.1% at room temperature. One way to produce concentrated liquid product containing tolylbenzotriazole is to mix solid tolyltriazole with a strong base such as a sodium hydroxide solution to form water-soluble sodium salt. The other way is to dissolve solid tolyltriazole in appropriate organic solvents such as methanol and ethylene glycol.

In addition, there are chemical additives that can not be formulated in aqueous solution due to their chemical instability in water. One example of this type of materials is methylene bisthiocyanate, a biocide for controlling microorganisms in water. Methylene bisthiocyanate decomposes in water. Therefore, it is normally dissolved in organic solvents to form a deliverable product.

Water treatment chemicals can also be delivered in a solid form. This approach involves transformation of all chemical additives into water-soluble solids that can be combined with solid binders or made into tablets. Special feed systems are required to control solid dissolution rates and to ensure proper water miscibility.

There are limitations experienced in current water treatment chemical delivery applications. First of all, water solubility of many chemical materials is too low to directly form concentrated products in aqueous media. A large number of chemicals with low water solubility are excluded from water treatment applications. Some of the additives with low water solubility require additional reagents to transform them into more water-soluble forms so that a concentrated aqueous product can be produced and delivered to water systems. In these cases, additional production steps are required, often associated with higher production cost and higher environmental risks. Secondly, using organic solvents may not be desirable in many field applications due to compatibility issues and concerns regarding storage, handling and transportation.

Thus, there is a need in the art for a simple, safe, convenient way to deliver chemical additives with low water solubility and low chemical stability.

### SUMMARY OF THE INVENTION

Chemical delivery media comprise a supporting substrate and desired chemical additives. The chemical additives, especially those with low water solubility and low chemical stability, are incorporated into the substrate network using a suitable organic solvent. Subsequent removal of the organic solvent results in an integrated delivery medium that releases chemical additives for water treatment system.

### DETAILED DESCRIPTION OF THE INVENTION

The chemical delivery media described in the present invention comprise a substrate that absorbs desired chemical additives for water treatment purposes. The substrate material can be organic and/or inorganic in nature. Ideally, the substrate should have a network type of structure with porosity and relatively large surface area where the desired chemical additives can be absorbed on the surface and incorporated throughout the network.

To incorporate and/or absorb desired chemical additives to the substrate, the chemical additives are dissolved in an organic solvent. The organic solvent is selected based on its boiling point as well as the solubility of the desired chemical additives. In general, the boiling point of the organic solvent should be below the decomposition temperature of the substrate and the boiling point of desired chemical additives. The organic solution with desired chemical additives can then be sprayed onto the substrate, or the substrate can be immersed into the organic solution so that the substrate fully absorbs the organic solution. The next step is to remove the organic solvent leaving the desired chemical additives on the substrate. This step can be accomplished by evaporating the solvents under ambient conditions or under heat or vacuum conditions, depending on the nature of the organic solvent. After the removal of the organic solvent, the substrate and the desired chemical additives are integrated in to one delivery medium that can be used for water treatment purposes.

To deliver desired chemical additives for water treatment, the prepared chemical delivery media are placed in the system with adequate water flow through the media composition. Depending on the solubility and stability of the chemical additives in aqueous solution, the chemical additives can be partially or fully transferred to the water systems and perform their desired functions.

### EXAMPLES

### Example 1

This Example demonstrates methods of preparing a chemical delivery medium for water treatment purposes.

A GE FXUSC Polyspun Sediment Filter Rev. 2 was selected as the substrate material. Two 1″×0.25″×0.25″ sections were cut out from the filter. One of the polyspun sections was used as control without further treatment (Medium A). The other was used as the substrate for the chemical delivery medium. The chemical additive chosen for the study was n-butylbenzotriazole (BBT). A solution of BBT in ethanol at 2% w/v was prepared. 0.25 mL of the BBT-Ethanol solution was transferred to the polyspun substrate. After BBT-ethanol solution was fully absorbed into the substrate network, ethanol was evaporated and removed using a heat-gun, leaving BBT evenly distributed in the substrate network (Medium B).

A bench top water recirculating systems was constructed to test BBT delivery to the water system. The system included a 1 L glass beaker, a hot plate with magnetic stirrer, and a water pump. The test water contained 400 mg sodium chloride in 1 L of de-ionized water. The water temperature was controlled at 50° C. The stifling rate was set at 400 RPM. A side-stream recirculation line was also installed. The water was constantly recirculating through Tygon tubings using a water pump set at 20 mL/min.

The medium was inserted into the Tygon tubing of the recirculation line. After one hour of water recirculation, the inserted medium was removed from the recirculation line. Water was sampled from the beaker and analyzed for BBT using a UV-Vis spectrophotometer. The results are shown in Table 1. The results indicate that BBT was released from the delivery medium (Medium B) and delivered to the bulk water.

TABLE 1

| | Absorbance | Estimated BBT |
|---|---|---|
| Sample | At 260 nm | mg/L |
| BBT/Ethanol, 5 mg/L | 0.24 | 5 |
| Di-ionized Water | 0.00 | Not detectable |
| Recirculated Water with Medium A | 0.00 | Not detectable |
| Recirculated Water with Medium B | 0.11 | 2.3 |

### Example 2

This Example demonstrates the applications of the disclosed chemical delivery media for water treatment purposes.

n-Butylbenzotriazole is known for its copper corrosion inhibition characteristics. The recirculating system demonstrated in Example 1 was used for corrosion inhibition test. Copper tube specimens, with 0.75″ in diameter and 1″ in length, were polished with sand paper, rinsed with de-ionized water, rinsed with ethanol, and dried in air.

After the bulk water in the beaker was recirculated through the medium inserted in the recirculation line for one hour, the medium was removed from the recirculation line. A copper specimen mounted on a sample holder was immersed in the water for a period of 21 days. During the testing period, water levels were constantly maintained at 1 liter. Water in the beaker was sampled periodically for analysis of copper. Table 2 shows the copper concentration in water that was treated with Medium A and B, respectively. The results show significantly higher copper level with water treated with Medium A. On the other hand, copper concentrations in water treated with medium B were negligible, indicative of effective copper corrosion inhibition by BBT delivered from the BBT delivery medium.

TABLE 2

| | Cu in water treated | Cu in water treated |
|---|---|---|
| Sample Time | with filter piece A | with filter piece B |
| (day) | (mg/L) | (mg/L) |
| 1 | 0.013 | <0.025 |
| 7 | 0.935 | <0.025 |
| 14 | 0.415 | <0.025 |
| 21 | 0.305 | <0.025 |

What is claimed is:

1. An integrated chemical delivery medium comprising at least one supporting substrate absorbed and/or incorporated with desired chemical additives.

2. A method of preparing the integrated delivery medium according to claim 1 by dissolving the chemical additives according to claim 1 in an organic solvent, transferring the organic solution to the substrate or immersing the substrate in the organic solution, and subsequently evaporating off the organic solvent.

3. A method of using the integrated chemical delivery medium in water treatment applications where the integrated chemical delivery medium according to claim 1 can be placed in a water system or a side-stream flow line with adequate water flow to release the chemical additives to the water system.

4. The substrate according claim 1 with porosity and surface areas where chemical additives can be absorbed onto the substrate surface and/or incorporated into the substrate network.

5. The substrate according to claim 1 being natural and/or synthetic materials, organic and/or inorganic in nature including but not limited to natural or synthetic fibers, textile or fabric materials, ceramics, zeolites, sand traps, water filtration media, etc.

6. The chemical additives according to claim 1 being chemicals with water solubility at room temperature below 1% w/w.

7. The chemical additives according to claim 1 being chemicals with solubility in an organic solvent according to claim 2 greater than 0.5% w/v.

8. The chemical additives according to claim 1 being chemicals that decomposes in aqueous environment but remain stable in suitable organic solvents.

9. The organic solvent according to claim 2 being organic solvents with boiling point below the decomposition temperature of the substrate according to claim 1.

10. The organic solvent according to claim 2 being organic solvents with boiling point below the boiling point of the chemical additives according claim 1.
